(19) United States
(12) Patent Application Publication
(10) Pub. No.: US 2013/0155088 A1
(43) Pub. Date: Jun. 20, 2013

(54) METHOD, APPARATUS AND SYSTEM FOR GENERATING AN IMAGE SLIDESHOW

(71) Applicant: CANON KABUSHIKI KAISHA, Tokyo (JP)

(72) Inventors: IJ Eric WANG, Sydney (AU); Jie XU, Sydney (AU); Mark Ronald TAINSH, Sydney (AU)

(73) Assignee: CANON KABUSHIKI KAISHA, Tokyo (JP)

(21) Appl. No.: 13/714,301

(22) Filed: Dec. 13, 2012

(30) Foreign Application Priority Data
Dec. 19, 2011 (AU) 2011265341

(51) Int. Cl. G06T 1/00

(52) U.S. Cl. CPC G06T 1/0007
USPC 345/581

(57) ABSTRACT

A method of generating an image slideshow is disclosed. A plurality of candidate images is accessed for the image slideshow. The method determines a plurality of subsections of reference images in a photo book. A corresponding set of the candidate images is selected for each of the determined subsections of the reference images, each set of candidate images being selected based on at least one attribute type of a corresponding determined subsection. The image slideshow is generated using at least one candidate image from each selected set of candidate images.

### CROSS-REFERENCE TO RELATED PATENT APPLICATIONS

The application claims the right of priority under 35 U.S.C. §119 based on Australian Patent Application No. 2011265341, filed 19 Dec. 2011, which is incorporated by reference herein in its entirety as if fully set forth herein.

### FIELD OF INVENTION

The present invention relates to a method for generating image slideshows from large sets of images and, in particular, to the generation of image slideshows that effectively deliver previously published stories. The present invention also relates to a method and apparatus for generating an image slideshow, and to a computer program product including a computer readable medium having recorded thereon a computer program for generating an image slideshow.

### DESCRIPTION OF BACKGROUND ART

Photographic images have long been used as an effective means of sharing experiences with people. In the past decades, the advent of digital photography has altered the behaviour of people in capturing images in the sense that it is more and more convenient to capture images. Meanwhile, development of massive storage media has made it possible for people to store an unlimited number of images. Both technologies have enabled people to share more images than before.

People capture images for various purposes. Images are actually outputs of decision processes. For example, a scene picture is captured because a photographer is impressed by the beauty of what is being seen. As another example, a family photograph is captured since the photograph is deemed that the moment is important for future reminiscence.

It is common nowadays that, when images are captured using digital cameras, additional information known as metadata is also recorded. Examples of such metadata include date, lens type, aperture, etc. FIG. 1A is a list of sample metadata that may be stored in an Exchangeable image file format (Exif) file associated with digital images. Such metadata is stored in the Exif file associated with each image. The metadata covers a broad spectrum including date and time information, camera settings and also copyright information. The metadata is as important as the images themselves, as the metadata can help to describe context of the captured images.

After images are captured, the images may be transferred from a camera to external storage. With traditional film photography, film rolls are taken out from camera, and developed into printed images (photographs). The developed images may be kept in envelopes and stored in closets. However, with the advent of digital photography, it has become more convenient to retrieve the captured images. Images from the digital cameras may be easily transferred to external storage devices, such as a hard disk drive and Compact Disc Read-Only Memories (CD-ROMs).

On the storage media, each image may be given an identifier which is a filename in the file system. Images are typically stored in folders, which can be labelled with key words that indicate the image content. Alternatively users may also learn about the image content in the folder by browsing thumbnail images. Due to convenience of capturing and retrieving images, nowadays people may have a large number of images stored on hard disk drives of personal computers and the like. To better manage the images, images may be annotated with text facilitating image retrieval.

Image annotation, also referred to as “tagging”, may be used to assign intuitive keywords to images. The keywords cover a wide spectrum of semantic understanding of images, which include events, objects, scenes, animals, etc. For example, keywords “Travel” and “Holiday” allow users to tag images as being related to travel and holiday, respectively. More tag examples may be found in FIG. 1B. Image tagging may be done either manually or automatically. Machine learning algorithms have been developed to tag images automatically. The algorithms study how tags are related to the image characteristics, and derive the patterns for tagging. Image tagging not only helps image organization but also assists image sharing in the future.

As mentioned above, a photographer's image archive may contain a large number of images, which are not suitable for sharing or presenting due to the lack of context. In comparison with the image archives, a popular method for sharing images is creating photo books, which are traditional books typically with images and text digitally printed on pages and case bound. Photo books are an effective and highly creative way of presenting a series of images for storytelling. The layout design and also the selected images reflect the intent of a creator for sharing. However, making a photo book is never a trivial task. It is usually time consuming and tedious to choose the appropriate images from a large image collection.

Despite the lengthy creating process, photo books are not generally a flexible option for image sharing, in the sense that it is usually difficult to engage people in image sharing using a photo book, especially to a large group of people. Due to the viewing constraints, only few people can view the photo book at the same time. Given the effort and time spent in making the photo book, such image sharing is not effective.

Online image publishing such as publishing image on the World Wide Web (WWW) via the Internet is becoming increasingly popular. In comparison with photo books, online image publishing websites, such as Flickr™ and Facebook™, offer people greater convenience and flexibility for photo sharing.

To enhance the storytelling and artistic effects of online image publishing, many online image publishing websites provide capability for viewing published images in slideshows, which automatically present images one at a time and sometimes with special transition effects. The transition effects between images may be customized according to the preference of a user and also content of the image. For example, Animoto™ is a rapid image slideshow generating Web application that allows users to customize a slideshow with music.

In comparison with photo books, the images in slideshows are often projected to large displaying apparatuses such as plasma monitors and televisions. As a result, image slideshows can produce a better user experience for photo sharing, especially to a group of people.

### SUMMARY OF THE INVENTION

It is an object of the present invention to substantially overcome, or at least ameliorate, one or more disadvantages of existing arrangements.

Disclosed are arrangements which assist users in sharing a growing image collection more effectively and creatively.

According to one aspect of the present disclosure there is provided a method of generating an image slideshow, said method comprising:
accessing a plurality of candidate images for the image slideshow;
determining a plurality of subsections of reference images in a photo book;
selecting a corresponding set of the candidate images for each of the determined subsections of the reference images, each said set of candidate images being selected based on at least one attribute type of a corresponding determined subsection; and
generating the image slideshow using at least one candidate image from each selected set of candidate images.
According to another aspect of the present disclosure there is provided an apparatus for generating an image slideshow, said apparatus comprising:
means for accessing a plurality of candidate images for the image slideshow;
means for determining a plurality of subsections of reference images in a photo book;
means for selecting a corresponding set of the candidate images for each of the determined subsections of the reference images, each said set of candidate images being selected based on at least one attribute of a corresponding determined subsection; and
means for generating the image slideshow using at least one candidate image from each selected set of candidate images.
According to still another aspect of the present disclosure there is provided a system for generating an image slideshow, said system comprising:
a memory for storing data and a computer program;
a processor coupled to said memory for executing said computer program, said computer program comprising instructions for:
   accessing a plurality of candidate images for the image slideshow;
   determining a plurality of subsections of reference images in a photo book;
   selecting a corresponding set of the candidate images for each of the determined subsections of the reference images, each said set of candidate images being selected based on at least one attribute of a corresponding determined subsection; and
   generating the image slideshow using at least one candidate image from each selected set of candidate images.
According to still another aspect of the present disclosure there is provided a computer readable medium having a computer program recorded there for generating an image slideshow, said program comprising:
code for accessing a plurality of candidate images for the image slideshow;
code for determining a plurality of subsections of reference images in a photo book;
code for selecting a corresponding set of the candidate images for each of the determined subsections of the reference images, each said set of candidate images being selected based on at least one attribute of a corresponding determined subsection; and
code for generating the image slideshow using at least one candidate image from each selected set of candidate images.

Other aspects of the invention are also disclosed.

### BRIEF DESCRIPTION OF THE DRAWINGS

One or more embodiments of the invention will now be described with reference to the following drawings, in which:

FIG. 1A is a list of sample metadata which may be associated with digital images;

FIG. 1B is a list of sample tags for images;

FIG. 1C is an example of a photo-book;

FIG. 2 is a schematic flow diagram showing a method of generating digital images;

FIG. 3 is a schematic flow diagram showing a method of generating a slide show.

FIG. 4 is a schematic flow diagram showing a method of determining subsections in a photo book and selecting candidate images for each determined subsection, as executed in the method of FIG. 3;

FIG. 5 is a schematic flow diagram showing an alternative method of determining subsections in a photo book and selecting candidate images for each determined subsection; and

FIGS. 6A and 6B form a schematic block diagram of a general purpose computer system upon which arrangements described can be practiced.

### DETAILED DESCRIPTION OF EMBODIMENTS OF THE INVENTION

Where reference is made in any one or more of the accompanying drawings to steps and/or features, which have the same reference numerals, those steps and/or features have for the purposes of this description the same function(s) or operation(s), unless the contrary intention appears.

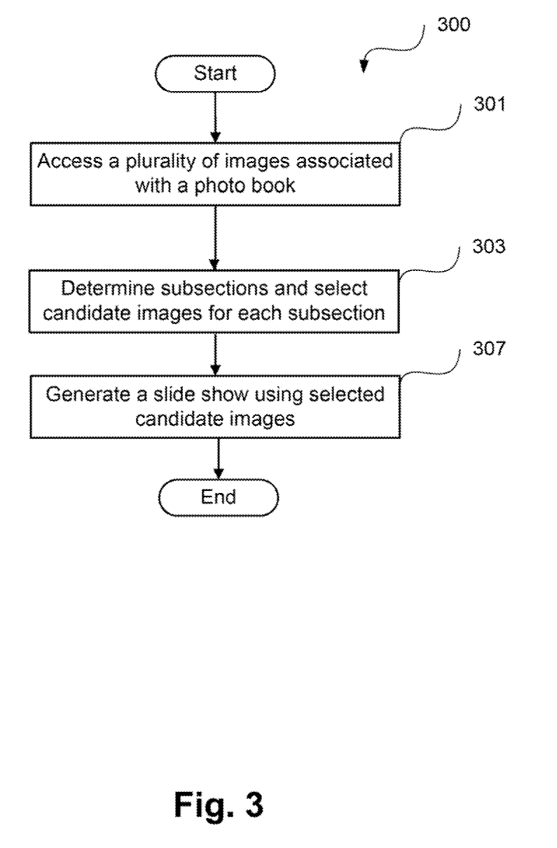

A method 300 (see FIG. 3) of generating an image slideshow, is described below with reference to FIG. 3. The method 300 enables users to effectively and creatively share a growing image collection with defined story context. The method 300 deduces the intent of a user in selecting images from a collection of images. The intent of a user is deduced from an inputted photo book.

A photo book consists of a set of images displayed coherently over pages. Before selecting images for a photo book, a photographer has to decide the theme of the photo book which governs content of images for the photo book. The theme reflects the intent of the photographer in making the photo book, and the theme determines which images to include in the photo book. Conversely, the selected images reflect the theme. For example, a photo book with a theme “Family Gathering” should contain family photos, whereas a photo book for a holiday trip would likely contain sight-seeing images.

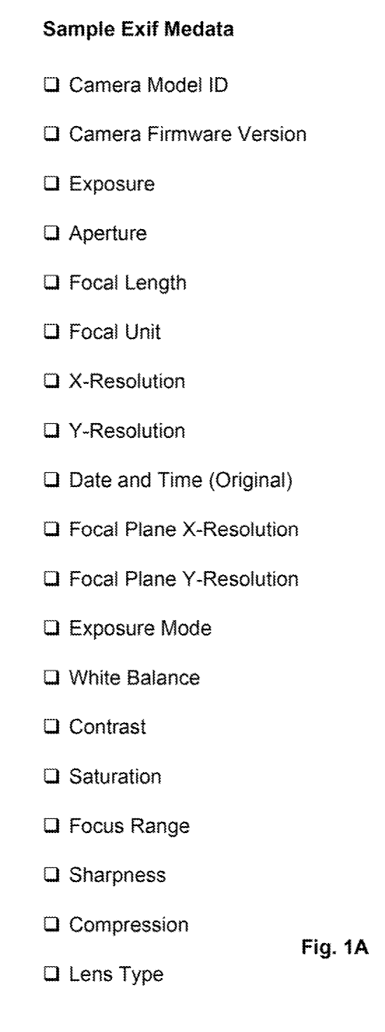

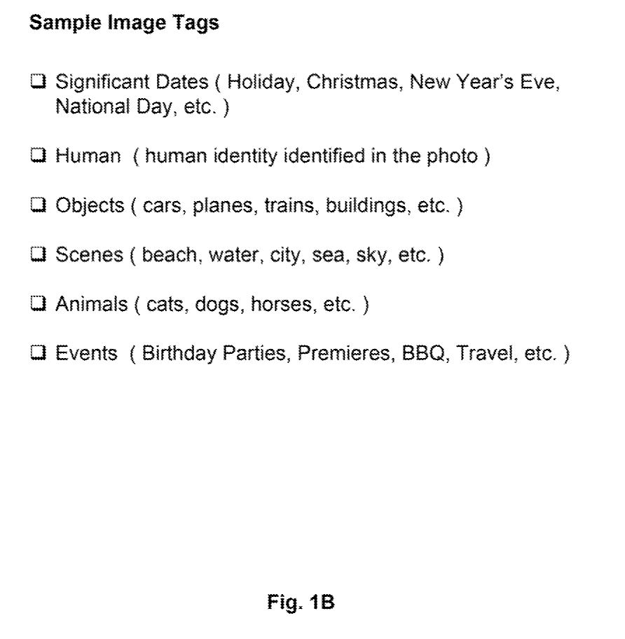

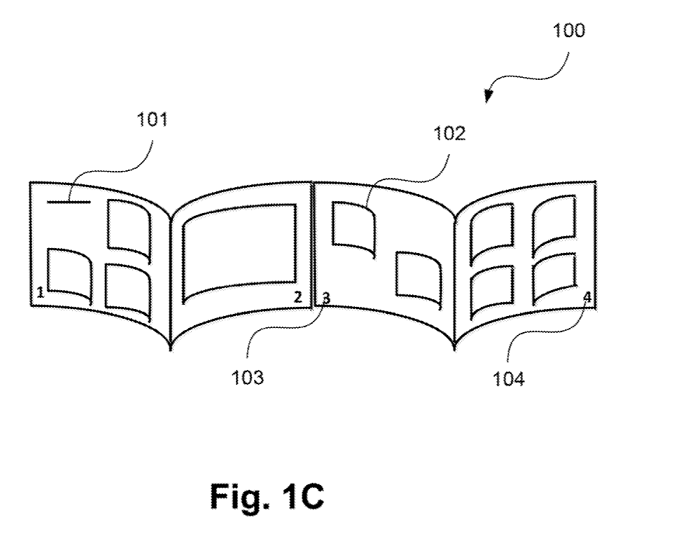

Once a theme is set for a photo book, images can be selected by matching tags or content associated with an image with the theme. After the images are selected, the user has to arrange the images over the pages of the photo book. Content related images are usually kept together on a photo book page or a spread that consists of multiple consecutive pages. On each page, the user can choose different layouts to arrange images. Example layouts include loose or overlapping arrangement of images, and panorama images. Additionally, the user can also set the background colour of each page. As an example, FIG. 1C shows a typical layout of a photo book 100. Both photo arrangement and page layout design show the intent of making the photo book 100.

Photo books may be generated either manually or automatically. Computer-aided photo book generation methods typically generate a photo book from an image repository automatically. The input to such an application includes images themselves as well as related metadata. The application may firstly cluster the images and then select representative images from each cluster, for the photo book. Since the selected images are representative images for the corresponding cluster, the selected images can well represent a story context that the user (or photographer) wants to deliver. Although photo books are more effective for photo sharing than image archiving, photo books are not a good option for sharing photos among a group of people due to viewing constraints. The method 300 achieves effective photo sharing for a group of people. A pre-created photo book may be used to define a story context for sharing.

The term “candidate images” below refers to digital images stored in a repository. The term “reference image” below refers to images inside a given photo book.

A photo slide show as described below is a presentation of a series of images with transitions between images. Each image of such a series may be referred to as a “slide”. However, a slide may comprise a plurality of images. For example, a slide may be in the form of an image collage comprising multiple images. Such a photo slide show may include videos and movies.

A set of candidate images as described below is a collection of candidate images that have correlated attribute values. A subsection of reference images as described below is a collection of reference images that have correlated attribute values.

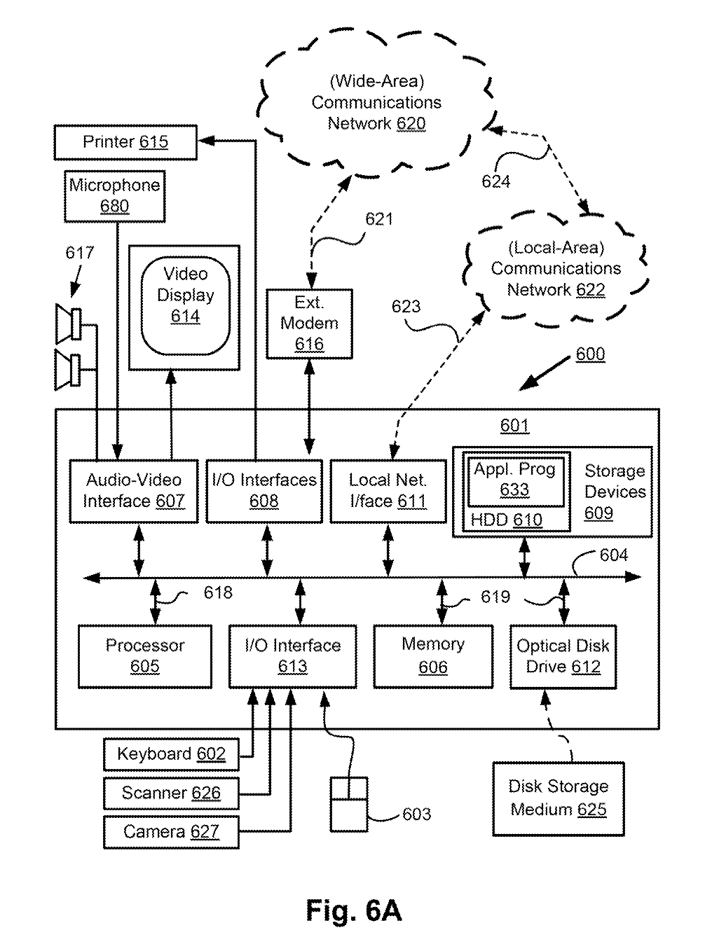

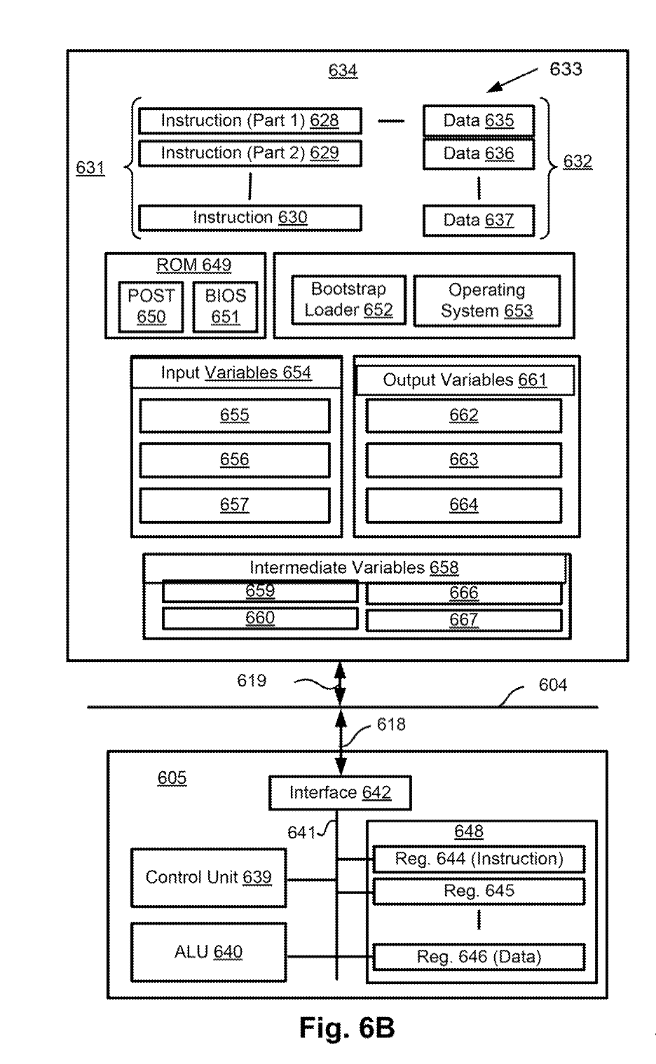

FIGS. 6A and 6B depict a general-purpose computer system 600, upon which the various arrangements described can be practiced.

As seen in FIG. 6A, the computer system 600 includes: a computer module 601; input devices such as a keyboard 602, a mouse pointer device 603, a scanner 626, a camera 627, and a microphone 680; and output devices including a printer 615, a display device 614 and loudspeakers 617. An external Modulator-Demodulator (Modem) transceiver device 616 may be used by the computer module 601 for communicating to and from a communications network 620 via a connection 621. The communications network 620 may be a wide-area network (WAN), such as the Internet, a cellular telecommunications network, or a private WAN. Where the connection 621 is a telephone line, the modem 616 may be a traditional “dial-up” modem. Alternatively, where the connection 621 is a high capacity (e.g., cable) connection, the modem 616 may be a broadband modem. A wireless modem may also be used for wireless connection to the communications network 620.

The computer module 601 typically includes at least one processor unit 605, and a memory unit 606. For example, the memory unit 606 may have semiconductor random access memory (RAM) and semiconductor read only memory (ROM). The computer module 601 also includes an number of input/output (I/O) interfaces including: an audio-video interface 607 that couples to the video display 614, loudspeakers 617 and microphone 680; an I/O interface 613 that couples to the keyboard 602, mouse 603, scanner 626, camera 627 and optionally a joystick or other human interface device (not illustrated); and an interface 608 for the external modem 616 and printer 615. In some implementations, the modem 616 may be incorporated within the computer module 601, for example within the interface 608. The computer module 601 also has a local network interface 611, which permits coupling of the computer system 600 via a connection 623 to a local-area communications network 622, known as a Local Area Network (LAN). As illustrated in FIG. 6A, the local communications network 622 may also couple to the wide network 620 via a connection 624, which would typically include a so-called “firewall” device or device of similar functionality. The local network interface 611 may comprise an Ethernet™ circuit card, a Bluetooth™ wireless arrangement or an IEEE 802.11 wireless arrangement; however, numerous other types of interfaces may be practiced for the interface 611.

The I/O interfaces 608 and 613 may afford either or both of serial and parallel connectivity, the former typically being implemented according to the Universal Serial Bus (USB) standards and having corresponding USB connectors (not illustrated). Storage devices 609 are provided and typically include a hard disk drive (HDD) 610. Other storage devices such as a floppy disk drive and a magnetic tape drive (not illustrated) may also be used. An optical disk drive 612 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 600.

The components 605 to 613 of the computer module 601 typically communicate via an interconnected bus 604 and in a manner that results in a conventional mode of operation of the computer system 600 known to those in the relevant art. For example, the processor 605 is coupled to the system bus 604 using a connection 618. Likewise, the memory 606 and optical disk drive 612 are coupled to the system bus 604 by connections 619. Examples of computers on which the described arrangements can be practised include IBM-PC's and compatibles, Sun Sparcstations, Apple Mac™ or a like computer systems.

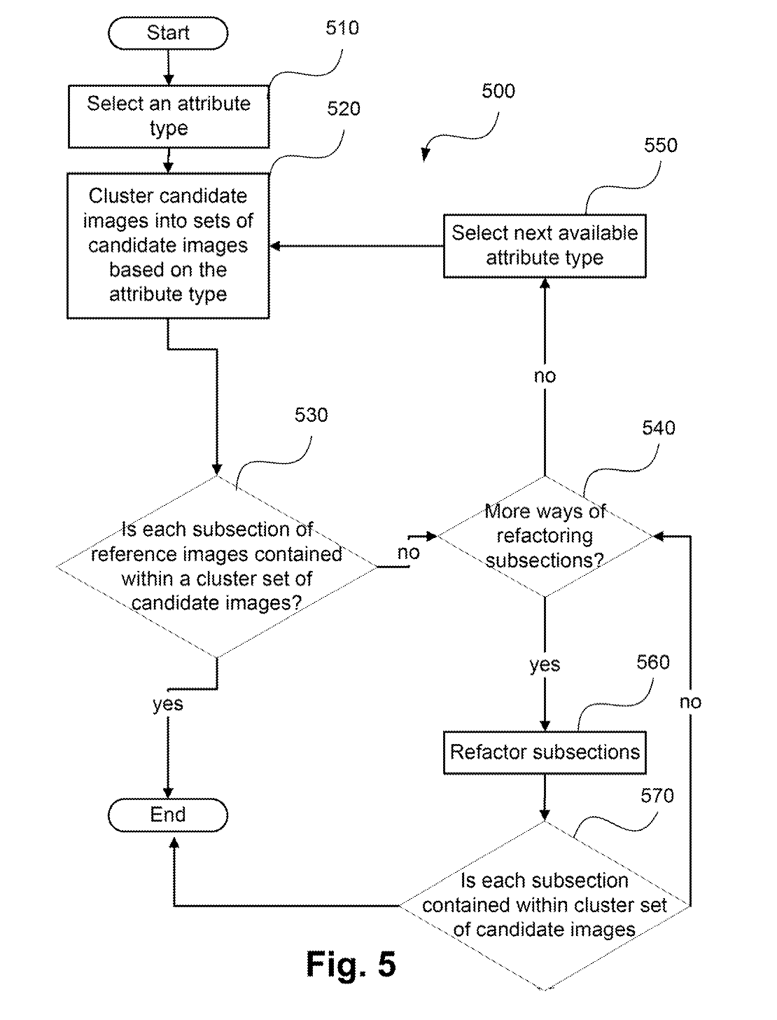

Methods described below may be implemented using the computer system 600 wherein the processes of FIGS. 1 to 5, to be described, may be implemented as one or more software application programs 633 executable within the computer system 600. In particular, the steps of the described methods are effected by instructions 631 (see FIG. 6B) in the software 633 that are carried out within the computer system 600. The software instructions 631 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software 633 is typically stored in the HDD 610 or the memory 606. The software is loaded into the computer system 600 from the computer readable medium, and then executed by the computer system 600. A computer readable medium having such software or computer program recorded on the computer readable medium is a computer program product. The use of the computer program product in the computer system 600 preferably effects an advantageous apparatus for implementing the described methods.

In some instances, the application programs 633 may be supplied to the user encoded on one or more CD-ROMs 625 and read via the corresponding drive 612, or alternatively may be read by the user from the networks 620 or 622. Still further, the software can also be loaded into the computer system 600 from other computer readable media. Computer readable storage media refers to any non-transitory tangible storage medium that provides recorded instructions and/or data to the computer system 600 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 601. Examples of transitory or non-tangible computer readable transmission media that may also participate in the provision of software, application programs, instructions and/or data to the computer module 601 include radio or infra-red transmission channels as well as a network connection to another computer or networked device, and the Internet or Intranets including e-mail transmissions and information recorded on Websites and the like.

The second part of the application programs 633 and the corresponding code modules mentioned above may be executed to implement one or more graphical user interfaces (GUIs) to be rendered or otherwise represented upon the display 614. Through manipulation of typically the keyboard 602 and the mouse 603, a user of the computer system 600 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 617 and user voice commands input via the microphone 680.

FIG. 6B is a detailed schematic block diagram of the processor 605 and a “memory” 634. The memory 634 represents a logical aggregation of all the memory modules (including the HDD 609 and semiconductor memory 606) that can be accessed by the computer module 601 in FIG. 6A.

When the computer module 601 is initially powered up, a power-on self-test (POST) program 650 executes. The POST program 650 is typically stored in a ROM 649 of the semiconductor memory 606 of FIG. 6A. A hardware device such as the ROM 649 storing software is sometimes referred to as firmware. The POST program 650 examines hardware within the computer module 601 to ensure proper functioning and typically checks the processor 605, the memory 634 (609, 606), and a basic input-output systems software (BIOS) module 651, also typically stored in the ROM 649, for correct operation. Once the POST program 650 has run successfully, the BIOS 651 activates the hard disk drive 610 of FIG. 6A. Activation of the hard disk drive 610 causes a bootstrap loader program 652 that is resident on the hard disk drive 610 to execute via the processor 605. This loads an operating system 653 into the RAM memory 606, upon which the operating system 653 commences operation. The operating system 653 is a system level application, executable by the processor 605, to fulfil various high level functions, including processor management, memory management, device management, storage management, software application interface, and generic user interface.

The operating system 653 manages the memory 634 (609, 606) to ensure that each process or application running on the computer module 601 has sufficient memory in which to execute without colliding with memory allocated to another process. Furthermore, the different types of memory available in the system 600 of FIG. 6A must be used properly so that each process can run effectively. Accordingly, the aggregated memory 634 is not intended to illustrate how particular segments of memory are allocated (unless otherwise stated), but rather to provide a general view of the memory accessible by the computer system 600 and how such is used.

As shown in FIG. 6B, the processor 605 includes a number of functional modules including a control unit 639, an arithmetic logic unit (ALU) 640, and a local or internal memory 648, sometimes called a cache memory. The cache memory 648 typically includes a number of storage registers 644-646 in a register section. One or more internal busses 641 functionally interconnect these functional modules. The processor 605 typically also has one or more interfaces 642 for communicating with external devices via the system bus 604, using a connection 618. The memory 634 is coupled to the bus 604 using a connection 619.

The application program 633 includes a sequence of instructions 631 that may include conditional branch and loop instructions. The program 633 may also include data 632 which is used in execution of the program 633. The instructions 631 and the data 632 are stored in memory locations 628, 629, 630 and 635, 636, 637, respectively. Depending upon the relative size of the instructions 631 and the memory locations 628-630, a particular instruction may be stored in a single memory location as depicted by the instruction shown in the memory location 630. Alternately, an instruction may be segmented into a number of parts each of which is stored in a separate memory location, as depicted by the instruction segments shown in the memory locations 628 and 629.

In general, the processor 605 is given a set of instructions which are executed therein. The processor 605 waits for a subsequent input, to which the processor 605 reacts to by executing another set of instructions. Each input may be provided from one or more of a number of sources, including data generated by one or more of the input devices 602, 603, data received from an external source across one of the networks 620, 602, data retrieved from one of the storage devices 606, 609 or data retrieved from a storage medium 625 inserted into the corresponding reader 612, all depicted in FIG. 6A. The execution of a set of the instructions may in some cases result in output of data. Execution may also involve storing data or variables to the memory 634.

The described methods use input variables 654, which are stored in the memory 634 in corresponding memory locations 655, 656, 657. The described methods produce output variables 661, which are stored in the memory 634 in corresponding memory locations 662, 663, 664. Intermediate variables 658 may be stored in memory locations 659, 660, 666 and 667.

Referring to the processor 605 of FIG. 6B, the registers 644, 645, 646, the arithmetic logic unit (ALU) 640, and the control unit 639 work together to perform sequences of micro-operations needed to perform “fetch, decode, and execute” cycles for every instruction in the instruction set making up the program 633. Each fetch, decode, and execute cycle comprises:
(a) a fetch operation, which fetches or reads an instruction 631 from a memory location 628, 629, 630;
(b) a decode operation in which the control unit 639 determines which instruction has been fetched; and
(c) an execute operation in which the control unit 639 and/or the ALU 640 execute the instruction.

Thereafter, a further fetch, decode, and execute cycle for the next instruction may be executed. Similarly, a store cycle may be performed by which the control unit 639 stores or writes a value to a memory location 632.

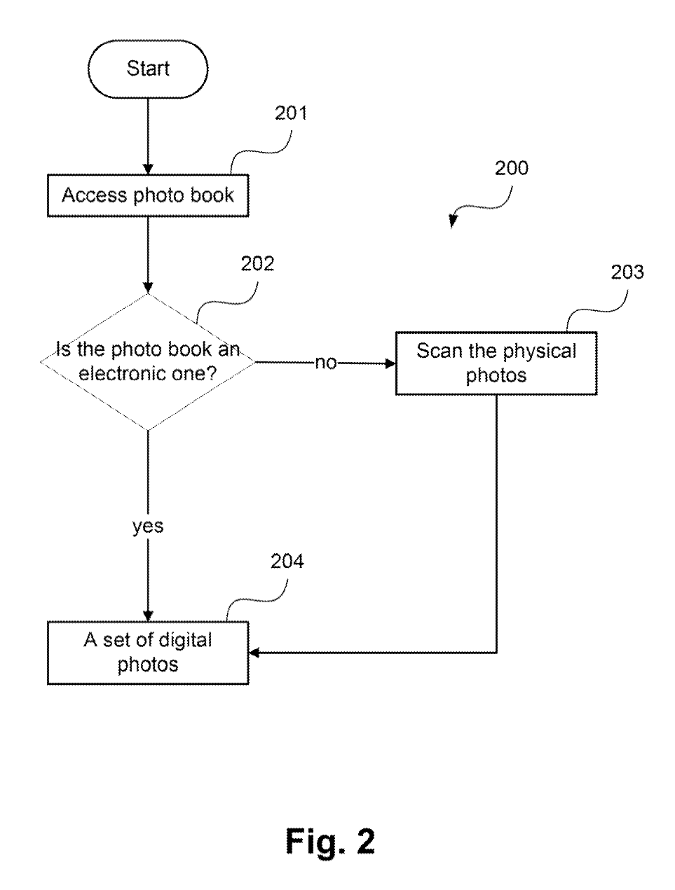

Each step or sub-process in the processes of FIGS. 2 to 5 is associated with one or more segments of the program 633 and is performed by the register section 644, 645, 647, the ALU 640, and the control unit 639 in the processor 605 working together to perform the fetch, decode, and execute cycles for every instruction in the instruction set for the noted segments of the program 633.

The described methods may alternatively be implemented in dedicated hardware such as one or more integrated circuits performing the functions or sub functions of the described methods. Such dedicated hardware may include graphic processors, digital signal processors, or one or more microprocessors and associated memories.

A method 200 of generating digital images is described below with reference to FIG. 2. The method 200 may be implemented as one or more software modules of the software application program 633 resident on the hard disk drive 610 and being controlled in its execution by the processor 605. The method 200 will be described by way of example with reference to the photo-book 100 of FIG. 1C.

The method 200 begins at accessing step 201, where the processor 605 may be used to access the photo-book 100. The photo-book 100 may be in the form of an electronic photo-book stored on the hard disk drive 610. Alternatively, the photo-book 100 may be in a printed hardcopy form.

At decision step 202, if the photo book is not in electronic form, then the method 200 proceeds to step 203. Otherwise, the method 200 proceeds to step 204.

At scanning step 203, the printed hardcopy of the photo-book 100 is scanned using the scanner 626, for example, to generate one or more digital images. The processor 605 may be used to store the generated digital images within the hard disk drive 610 and/or the memory 606.

At storing step 204, the processor 605 is used to store one or more digital images (e.g., 102) from the photo-book 100 within the memory 606.

The method 300 of generating an image slideshow will now be described below with reference to FIG. 3. The method 300 may be implemented as one or more code modules of the software application 633 resident on the hard disk drive 610 and being controlled in its execution by the processor 105.

The method 300 begins at accessing step 301, where the processor 605 accesses one or more of the images, associated with the photo-book 100, from the memory 606 and/or the hard disk drive 610. The accessed images are used as reference images for context setting.

At determining step 303, the processor 605 is used for determining subsections of reference images in the photo book 100 and selecting candidate images for each determined subsection. A subsection is a contextual unit, which contains reference images that share some common attribute values in regard to an attribute type. For example, reference images in one subsection may share a value of “Italy” in regard to the ‘location’ type if the images are captured in ‘Italy’, while reference images in another subsection may share a value of the same date in regard to the ‘date’ attribute type if the images are captured on the same date. The subsections define the context of the photo book 100.

In one arrangement, a first set of candidate images and a corresponding subsection of reference images may be selected based on a first property. Further, a second set of candidate images and a corresponding subsection of reference images may be selected based on a second property, where a property is a combination of attribute type and attribute value, and the first property may be different to the second property. For example, the attribute type of the first property may be different to the attribute type of the second property. Alternatively, both properties may have the same attribute type but different attribute values.

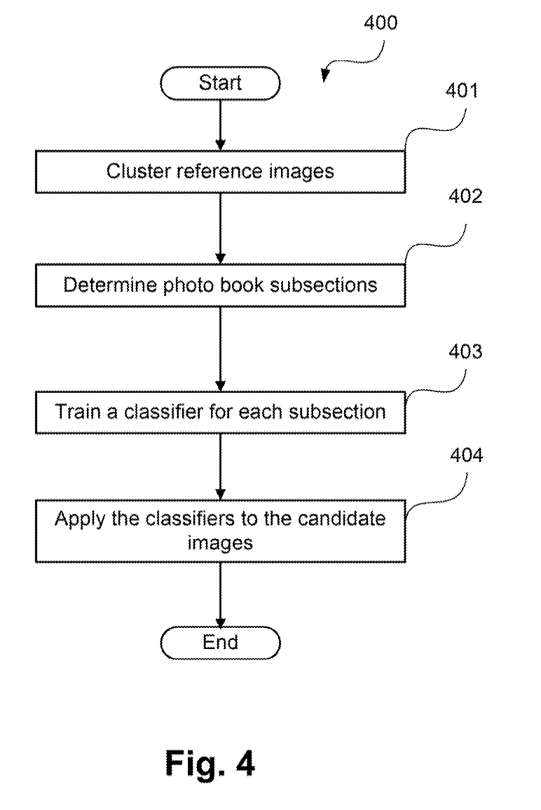

Also at step 303, the processor 605 is used for selecting a corresponding set of candidate images for each determined subsection of the reference images in the photo book 100. The sets of candidate images are selected at step 303 based on attribute types of a corresponding determined subsection. The processor 605 may be used for accessing the candidate images for the image slideshow from a repository of images configured, for example, within the hard disk drive 610. The candidate images may be stored within the memory 606. A method 400 of determining subsections in the photo book 100 and selecting candidate images for each determined subsection, as executed at step 303, will be described in detail below with reference to FIG. 4.

The method 300 concludes at generating step 307, where the processor 605 is used for generating an image slide show using the candidate images selected at step 303. In one arrangement, at least one candidate image from each selected set of candidate images is used in the generated image slideshow. As described in detail below, images used in the generated slide show deliver at least a similar story context to the photo book 100. Step 307 requires no user effort in image selections.

The method 300 may use machine learning algorithms to generate the slide show. To determine the subsections in the photo book 100 at step 303, image analysis is performed on the images of the photo book 100. Each image (e.g., 102) in the photo book 100 and also the candidate images may be described using attribute types, such as location, time, colour and texture. As a result, each image of the slide show may be represented as a feature vector in high dimensional feature space.

The method 400 of determining subsections in the photo book 100 and selecting candidate images for each determined subsection, as executed at step 303, will be described in detail below with reference to FIG. 4. The method 400 may be implemented as one or more code modules of the software application program 633 and being controlled in its execution by the processor 605.

The method 400 begins at clustering step 401, where a clustering algorithm, such as the “k-means” algorithm, is executed by the processor 605 to cluster feature vectors for the reference images. Each reference image is then assigned to a cluster of reference images. A cluster membership distribution is calculated at step 401 for each page (e.g., 103) in the photo book 100. The similarity of membership distribution between adjacent pages may be calculated using a χ² distance metric defined in accordance with Equation (1) below:

$$d ( {K}_{1} , {K}_{2} ) = {\sum }_{i} \frac{{( {K}_{1} ( i ) - K ( i ) )}^{2}}{K ( i )} , \qquad ( 1 )$$

where K₁ and K₂ represent member distributions for two adjacent pages of the photo book 100, respectively, and K(i)=[K₁(i)+K₂(i)]/2.

Then at determining step 402, the processor 605 is used to determine one or more subsections for the photo book 100 by assigning pages (e.g., 103) of the photo book 100 to different subsections of the photo book 100 depending on content of the pages of the photo book 100. By setting a threshold α to the similarity measures (e.g., the distance metric described above), adjacent pages with higher similarity are assigned to one subsection. In contrast, adjacent pages with low similarity may be assigned to different subsections. Alternatively, in addition to image analysis, subsections may also be determined using section headings, pagination and style changes, as people usually place images with different content into sections of a photo book with different titles. Details of the pages assigned to each subsection of the photo book 100 may be stored in the memory 606 and/or the hard disk drive 610.

The method 400 continues at step 403, where the processor 605 is used to train a Multiple Kernel Support Vector Machine (MK-SVM) classifier for each subsection of the photo book 100, as described in detail below. In particular, after the subsections are determined at step 402, another image analysis may be performed on the pages (e.g., 103) of the photo book 100 at step 403 to determine the context inside each subsection of the photo book 100. As described above, each image may be described using attributes types such as location, time and image content. Similarly, the context in each subsection of the photo book 100 may also be described using such attribute type, as location, time and image content.

Different weights β̅=[β₁, β₂, β₃] may be assigned to the attribute types. The weights assigned to the different attribute types associated with each subsection reflect subsection context. For example, a location attribute type associated with a subsection and having a weight value of 0.90 means that most images in the subsection share similar location. As another example, a weight value of 0.10 for attribute type time means that most images of the subsection share different time stamps.

Subsection context also represents weight factors. The weight factors may be estimated for each subsection using a Multiple Kernel Support Vector Machine (MK-SVM). MK-SVM is an advanced Support Vector Machine (SVM), which constructs a hyper plane to separate data in high dimensional space. A hyper plane is constructed based on feature similarity measure between training data. An SVM may determine feature similarity measure based on a single attribute type only. In contrast, MK-SVM may consider similarity of multiple attribute types. MK-SVM may be configured to construct a hyper plane for classification using linearly weighted feature similarity measures. For each subsection of the photo book 100, reference images may be used as positive training data while those images in other subsections of the photo book 100 are used as negative training data. An MK-SVM classifier is trained for each subsection 100. The MK-SVM classifier associated with a subsection contains a set of weight factors for the subsection.

Once a set of MK-SVM classifiers are trained for each subsection of the photo book 100 respectively, at the next step 404, the processor 605 is used to apply a MK-SVM classifier to the candidate images (e.g., stored within the repository of images as described above). Candidate images sharing consistent properties are selected for each corresponding subsection of the photo-book 100. Accordingly, the story context of the photo book 100 is retained in the selected candidate images.

As described above, at generating step 307, a slide show is generated using the candidate images selected at step 303.

The method 400 uses supervised learning to select the candidate images. Such supervised learning requires a certain number of images to achieve good performance.

In one arrangement, when there are scarce training samples, an alternative method 500 of determining subsections of the photo book 100 and selecting candidate images for each determined subsection may be executed at step 303. The method 500 is a clustering based method. In contrast to the method 400, the method 500 relies on unsupervised learning to discover relationships between the reference and candidate images.

The method 500 applies clustering algorithms to the candidate and reference images respectively. Subsections of the photo book 100 are determined in accordance with the method 500 from clustering the reference images, whereas the candidate images may be selected by clustering the candidate images. The method 500 iteratively matches the subsections of the photo book 100 with the candidate images repeatedly until a good match is determined.

The method 500 of determining subsections of the photo book 100 and selecting candidate images for each determined subsection, as alternatively executed at step 303, may be implemented as one or more code modules of the software application program 633 resident on the hard disk drive 610 and being controlled in its execution by the processor 605.

In accordance with the method 500, candidate images are clustered into sets based on a type of attribute. A subsection of reference images corresponds to a set of candidate images if the subsection of reference images is contained within the set of candidate images.

The method 500 begins at an attribute type selection step 510, where the processor 605 is used to select an attribute type such as time, location, and image content.

Based on the selected attribute type, at clustering step 520, candidate images are clustered into sets of candidate images using a clustering algorithm. One clustering algorithm that may be used at step 520 is the “k-means” clustering algorithm, which requires the number of clusters of candidate images as an input.

Alternatively, clustering algorithms that require no pre-determined number of clusters may be used at step 520. For example, the Affinity Propagation (AP) clustering algorithm may be used at step 520. The Affinity Propagation clustering algorithm does not require the number of clusters as an input. The Affinity Propagation (AP) clustering algorithm takes measures of similarity between pairs of data points as input. During the clustering, real-valued messages are exchanged between data points until a high-quality set of cluster centres and their corresponding clusters are determined.

Unlike the candidate images, reference images are assigned into subsections of the photo book 100 based on physical characteristics of the photo book 100, such as headings, pagination, and also text associated with the pages (e.g., 103) of the photo book 100. The subsections of the photo book 100 may be determined based on physical characteristics of the photo book 100. In particular, the photo book 100 may be factorized into subsections using the physical characteristics (e.g., headings, pagination and text) selected at step 510. Pages (e.g., 103, 104) of the photo book 100 are assigned to the different subsections of the photo book 100 depending on the physical characteristics associated with each page of the photo book 100. Again, details of the pages assigned to each subsection of the photo book 100 may be stored in the memory 606 and/or the hard disk drive 610.

At decision step 530, the processor 605 is used to determine if each subsection of reference images of the photo book 100 is contained within a set of candidate images determined at step 520. If each subsection of reference images is contained within a set of candidate images determined at step 520, then the method 500 concludes. Otherwise, the method 500 proceeds to step 540.

To determine whether a subsection is contained within a set of candidate images at step 530, the similarity of the reference images in the subsection and the candidate images in the set of candidate images is determined based on a similarity measure (e.g., the distance metric described above).

If the similarity measure is higher than a predefined threshold at step 530, then the subsection is determined to be contained within the set of candidate images and the method 500 concludes. If the similarity is lower than the threshold, then the method 500 proceeds step 540.

At step 540, the processor 605 is used to determine if there is a different method of subsection refactoring that may be used to amend the subsections of the photo book 100 determined at step 520. For example, originally each subsection of the photo book 100 determined at step 520 may correspond to a single page of the photo book. In this instance, an amendment may be made to the determined subsections of the photo book 100 so that a spread of several pages (e.g., pages 103, 104) forms a subsection based on the page headings of the pages 103 and 104. If there is a different method of subsection refactoring that may be used to amend the subsections of the photo book 100 determined at step 520, then the method 500 proceeds to step 560. Otherwise, the method 500 proceeds to step 550 where the processor 605 is used to select a next available type of attribute before the method 500 returns to step 520.

At step 560, the processor 605 is used to factorize the photo book 100 into further subsections. Once the subsections are refactored at step 560, at decision step 570, the processor 605 is used to compare reference images of the subsections determined at step 560 to the sets of candidate images. If each subsection of the photo book 100 is contained within a set of candidate images determined at step 560, then the method 500 concludes. Otherwise, the method 500 returns to step 540.

Steps 540 to 570 of the method 500 are repeated until there is a matched set of candidate images for each subsection of the photo book 100, or there is no further method of subsection refactoring.

Accordingly, in steps 520 to 570, the processor 605 is used for successively clustering the candidate images into sets based on different attribute types. The steps 520 to 570 are repeated until the sets of candidate images and the subsections of the photo book 100 agree on a selected attribute type and a way of subsection refactoring. In one arrangement, the subsections of the photo book 100 may be determined using physical characteristics of the photo book 100, such as titles and paginations.

Both the methods 400 and 500 can identify the candidate images for the slide show. Specifically, the methods 400 and 500 both establish correspondence between subsections and subsets of candidate images. The subsets of candidate images are referred to as “candidate image groups” below. Each candidate image group has a corresponding subsection.

As described above, at generating step 307, a slide show is generated from the candidate images. In one arrangement, the created slide show may be composed of a sequence of individual images selected from each successive candidate image group in the same order as the subsections corresponding to each candidate image group. Once an individual image is selected from the candidate image group corresponding to a last subsection, a further sequence of individual images may be selected from each successive candidate image group in the same manner. Selection of the further sequence of individual images may start with selection of a different individual image from the candidate image group corresponding to a first subsection.

As described above, a photo slide show is a presentation of a series of images with transitions between images, where each image of such a series may be referred to as a “slide”. However, as also described above, a slide may comprise a plurality of images. In an alternative arrangement, instead of selecting an individual image from each of the candidate image groups as described above, the number of images selected for each successive slide of a slide show may be the same as the number of reference images in a corresponding subsection of an original photo book (e.g., 100). The selected images from a candidate image group may be displayed at the same time in the form of image collages. For example, if there are two reference images in a subsection, then the slide corresponding to the subsection will be an image collage made up of two images selected from the candidate image group corresponding to the subsection. Further slides of the slide show may be determined for each successive candidate image group, again, in the same order as the subsections corresponding to each candidate image group. Similarly to the arrangement described above, once images are selected from the candidate image group corresponding to a last subsection, further images may be selected for a further slide for each corresponding subsection starting from the candidate image group corresponding to a first subsection.

In still a further alternative arrangement, the generated slide show may comprise more than one successive slide corresponding to each subsection of an original photo book (e.g., 100). For example, the slide show may have slides one, two and three containing images from the candidate image group corresponding to the first subsection. Further, slides four and five of the slide show may contain images from the candidate image group corresponding to the second subsection.

In the arrangements described above, images are selected from the candidate image groups for inclusion in the slide show. In one alternative arrangement, images may be selected randomly. In another alternative arrangement, images that are considered representative and summarise or exemplify many other images in the candidate image group may be selected for inclusion in the slide show. In still another arrangement, a representative image may include a large number of the people present at an event, which serves to summarise other images that contain the same people individually. In one arrangement, a representative image may be an object frequently photographed by the user, such as a mountain summit on a hike event, a boat on a fishing event, or a car on a road-trip event, where such objects are detected using image processing techniques.

In one arrangement, an image selected for a slide show may be an image with high technical quality, such as correct focus, optimal exposure, high dynamic range, and so on. In one arrangement, images that provide continuity between previous and following images of the slide show may be selected. In one arrangement, diverse images that guarantee good coverage may be selected for the image slide show.

### INDUSTRIAL APPLICABILITY

The arrangements described are applicable to the computer and data processing industries and particularly for the image processing.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of generating an image slideshow, said method comprising:
accessing a plurality of candidate images for the image slideshow;
determining a plurality of subsections of reference images in a photo book;
selecting a corresponding set of the candidate images for each of the determined subsections of the reference images, each said set of candidate images being selected based on at least one attribute type of a corresponding determined subsection; and
generating the image slideshow using at least one candidate image from each selected set of candidate images.

2. The method according to claim 1, further comprising:
selecting a first set of candidate images and a corresponding subsection of reference images sharing a first property; and
selecting a second set of candidate images and a corresponding subsection of reference images sharing a second property said first property being different to the second property and where a property is a combination of attribute type and attribute value.

3. The method according to claim 2, wherein the first attribute type is different to the second attribute type.

4. The method according to claim 2, wherein first and second attribute type are the same but first attribute value is the different to second attribute value.

5. The method according to claim 1, wherein the subsections of reference images are determined based on physical characteristics of the photo book.

6. The method according to claim 1, wherein the candidate images are clustered into sets based on an attribute type.

7. The method according to claim 6, wherein a subsection of reference images corresponds to a set of candidate images if the subsection of reference images is contained within the set of candidate images.

8. The method according to claim 1, further comprising successively clustering the candidate images into sets based on different attribute types.

9. An apparatus for generating an image slideshow, said apparatus comprising:
means for accessing a plurality of candidate images for the image slideshow;
means for determining a plurality of subsections of reference images in a photo book;
means for selecting a corresponding set of the candidate images for each of the determined subsections of the reference images, each said set of candidate images being selected based on at least one attribute of a corresponding determined subsection; and
means for generating the image slideshow using at least one candidate image from each selected set of candidate images.

10. A system for generating an image slideshow, said system comprising:
a memory for storing data and a computer program;
a processor coupled to said memory for executing said computer program, said computer program comprising instructions for:
accessing a plurality of candidate images for the image slideshow;
determining a plurality of subsections of reference images in a photo book;
selecting a corresponding set of the candidate images for each of the determined subsections of the reference images, each said set of candidate images being selected based on at least one attribute of a corresponding determined subsection; and
generating the image slideshow using at least one candidate image from each selected set of candidate images.

11. A computer readable medium having a computer program recorded there for generating an image slideshow, said program comprising:
code for accessing a plurality of candidate images for the image slideshow;
code for determining a plurality of subsections of reference images in a photo book;
code for selecting a corresponding set of the candidate images for each of the determined subsections of the reference images, each said set of candidate images being selected based on at least one attribute of a corresponding determined subsection; and
code for generating the image slideshow using at least one candidate image from each selected set of candidate images.
